(19) United States
(12) Patent Application Publication
(10) Pub. No.: US 2007/0203989 A1
(43) Pub. Date: Aug. 30, 2007

(54) Process for direct transmission of email messages, when possible, falling back to traditional transmission when not possible

(76) Inventor: Daniel James Cappannari, Franklin, TN (US)

Correspondence Address: Dan Cappannari, 1330 Summer Haven Cr, Franklin, TN, 37069, US

(21) Appl. No.: 11/361,790

(22) Filed: Feb. 25, 2006

(51) Int. Cl. G06F 15/16

(52) U.S. Cl. 709/206

(57) ABSTRACT

A process for direct transmission of email messages, when possible, falling back to traditional transmission when not possible with the steps of: Standard email client software provides the entire user interface to this system, A client program then becomes the email server with which this standard email client software communicates, and The client program then communicates with the emailshooter locator server, which tells the client software whether the recipient is a participant in the service.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of electronic mail and more specifically to a process for direct transmission of email messages, when possible, falling back to traditional transmission when not possible.

Electronic mail began with the telegraph over 100 years ago. Transmission of electronic messages saw little progress until the computer age. Early efforts, operated by owners of existing networks such as Western Union, ITT, and MCI, are now defunct.

Modern email was one of the Internet Protocols, along with HTTP (web sites) and FTP (file transfer). Since then it has become an integrated part of every day life for people in any industrial society.

It is interesting to note that the inadequacy of the grandfather of all electronic mail—the telegraph—is still inherent in modern message transmission systems. That is that a third party was and is still required to handle transmission and delivery of information. 100 years ago, a letter was taken to a telegraph office. It was the responsibility of the telegraph company to transmit the telegraph to a remote location, where company employees were responsible for delivering the message to the recipient.

This is analogous to modern electronic mail. The sender must first upload a message to his or her own internet provider (similar to taking a message to Western Union). That internet provider's mail server must then transmit the message to the recipient's internet provider's mail server (similar to transmission of the telegraph). Finally, the recipient's mail server must deliver the message to the recipient (similar to the remote telegraph office hand delivering the message to the recipient).

In one respect modern electronic mail is more deficient than telegraphs were: whereas a single company ran telegraph offices worldwide, it is unlikely that that the sender and recipient of an email message even use the same ISP. When there is a failure, this makes identifying the fault more difficult.

To summarize, modern email is more complex than the telegraph, but emailshooter is as direct as a phone call—as if everybody had their own telex machine.

### BRIEF SUMMARY OF THE INVENTION

The primary object of the invention is The delay of store and forward email delivery is eliminated.

Another object of the invention is Delivery of emails sent directly is guaranteed.

Another object of the invention is The size of email attachments is unlimited.

A further object of the invention is Direct delivery is more secure than store and forward delivery.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for direct transmission of email messages, when possible, falling back to traditional transmission when not possible comprising the steps of: Standard email client software provides the entire user interface to this system, A client program then becomes the email server with which this standard email client software communicates, and The client program then communicates with the emailshooter locator server, which tells the client software whether the recipient is a participant in the service. When both computers are connected to the internet, email is thus sent directly between two computers rather than indirectly through the mail servers of two separate internet providers. This is more secure, more simple, and much faster.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a schematic block diagram of the delivery of an email message using current technology.

Arrows with red tips indicate actual transfer of the message and arrows with black tips indicate communication with the domain name system (DNS).

Once a message is composed, the sender's PC must transmit the message to the mail server provided as part of internet service to the sender. The name of that mail server is usually specified in terms of a hostname such as mail.aol.com, so the sender's PC must use DNS to translate that hostname to an IP before connecting to the mail server and depositing it for “relay”.

Now the mail server operated by the sender's ISP must itself use DNS to determine the name of the mail server provided by the recipient's ISP, and use DNS a second time to translate that name to an IP address before it can connect and relay the message to the receiving mail server.

The receiving mail server must store this message until the recipient's computer checks for new email. This involves asking the DNS for the transaction of the receiving mail server name (such as mail.dol.net). Finally, the recipient's computer may connect and receive the message.

FIG. 2 is a schematic block diagram showing how emailshooter accomplishes the same task. Both computers must be connected to the internet. The email shooter software on the receiving computer will contact the emailshooter locator with information of the form “for emails going to bob.smith@dol.net, here is the current IP address”.

Once the message is composed, the sending computer asks the locator service if bob.smith@dol.net is online; the answer is yes, and here is his IP address. This permits the sending computer to directly connect to the recipient's computer and send the message.

This reduces the number of transmissions of the message to ⅓ of what traditional email uses, and it replaces 5 uses of DNS with 2 uses of the locator service.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

To provide a fully detailed description of this invention it is necessary to review (1) how traditional email delivery is accomplished, then (2) how emailshooter bypasses this mechanism, and then (3) explain how emailshooter and traditional email can seamlessly coexist as correspondents migrate from the older system to the newer one.

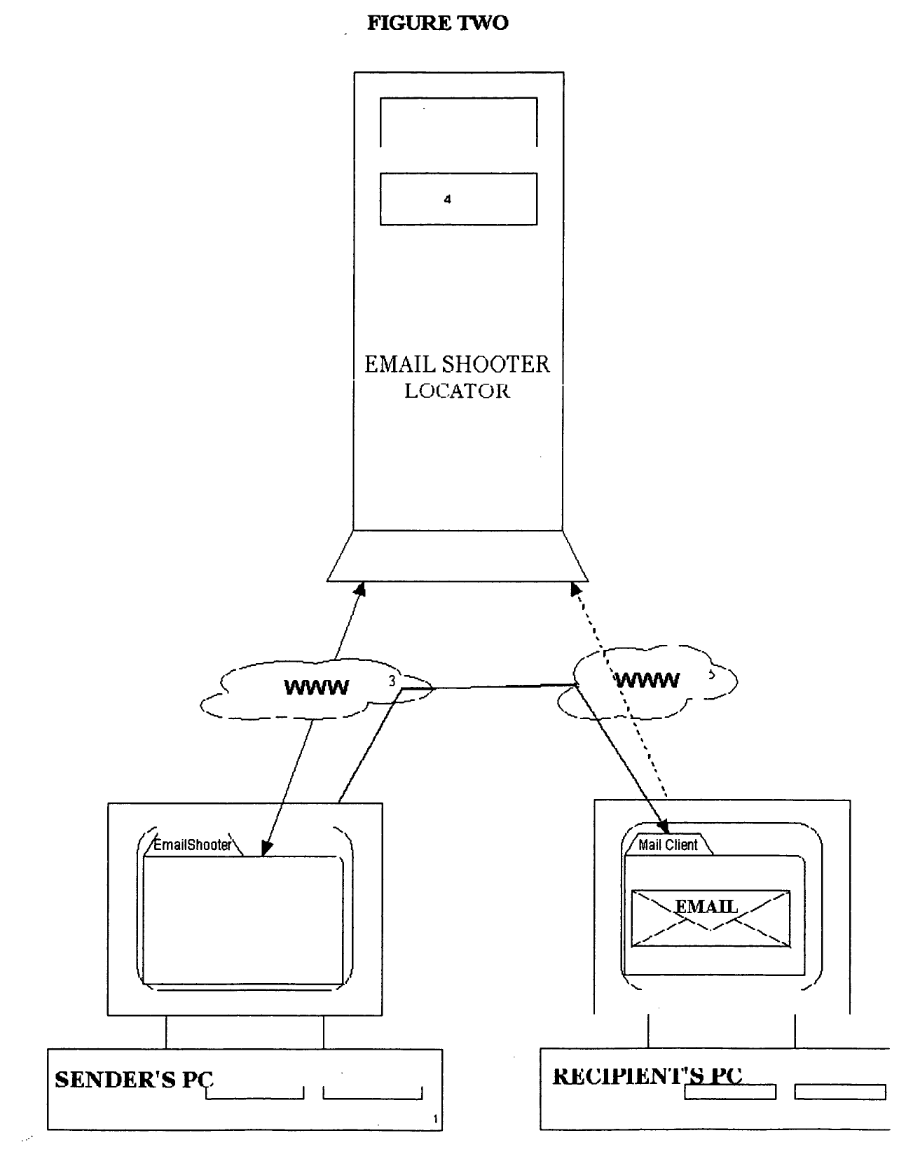

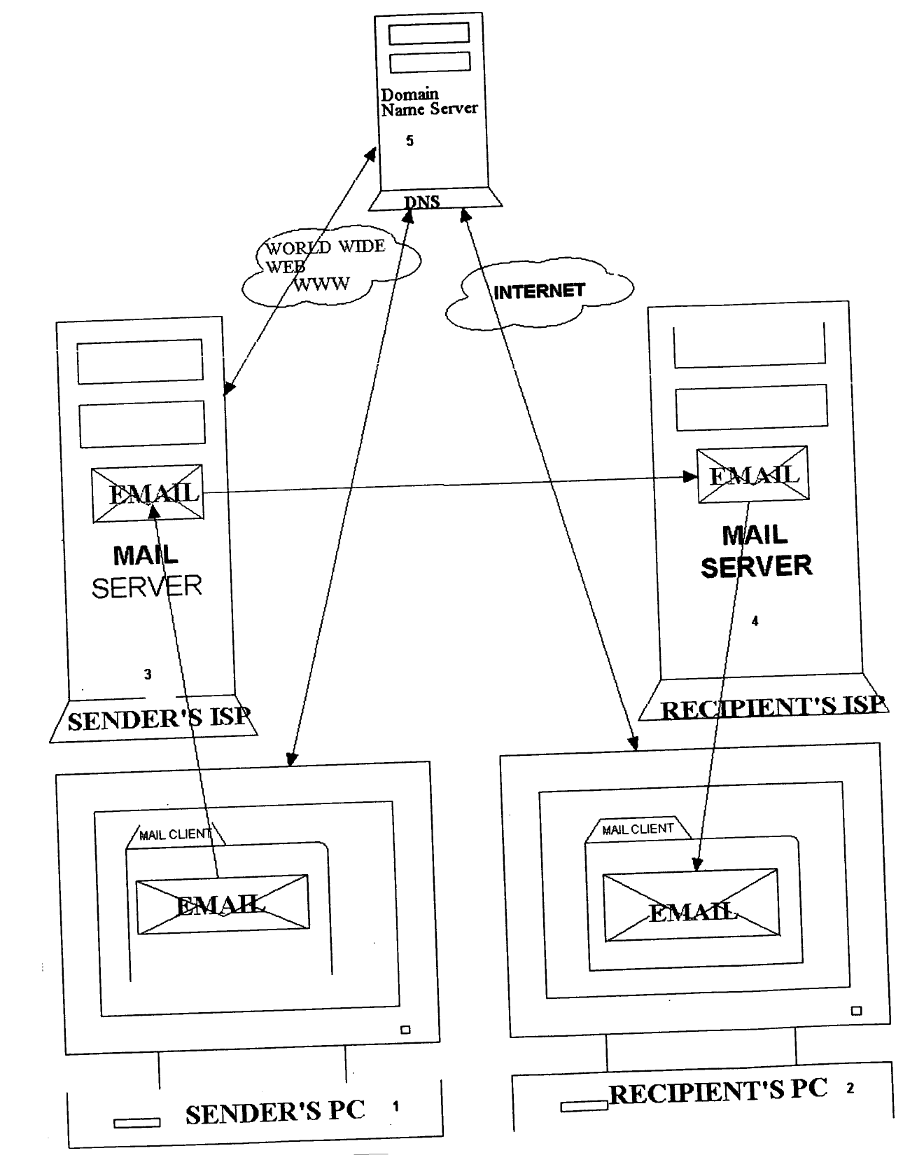

Traditional email delivery is depicted in FIG. 1 and consists of the following steps:
1. The email client (such as Outlook Express) on the sender's PC (1) must use DNS (5) to translate a mail server name such as “mail.dol.net” to an IP address.
2. The email client transmits the message to the sender's mail server (3).
3. The sender's mail server (3) must use DNS (5) to determine the mail server of the recipient (4).
   4. The sender's mail server (3) must use DNS (4) to translate this hostname to an IP address.
5. The sender's mail server (3) transmits the message to the recipient's mail server (4).
6. The message is retained, waiting for the recipient to retrieve it.
   7. The recipient's email client (2) must use DNS (5) to translate the recipient's mail server name to an IP address.
8. The recipient's email client retrieves the message from the recipient's mail server (4).

Emailshooter “short circuits” many of these steps. Emailshooter delivery is depicted in FIG. 2:
1. The email client (1) “transmits” the email message to Emailshooter. This is a transfer within the PC which requires no Internet.
   2. Emailshooter (1) communicates with the locator service (4) and discovers that the recipient is online. An ip address for the recipient's computer is obtained.
3. Emailshooter (1) transmits the message directly to the recipient's computer (2).
4. The recipient's email client receives it from Emailshooter on the recipient's PC (2).
Again, no use of the Internet is made.

This direct transmission halves the steps required to send an email message as well as halving the number of computers the email message resided on. The first reduction results in more efficient delivery, eliminating the delay described in step 6 above. The second reduction ensures that the mail delivery is secure.

Finally, we must consider what Emailshooter will do if the recipient is not online when the sender attempts to send the message. In this case, the first two steps of the second list are still conducted. At this point, Emailshooter simply transmits the message to the sender's mail server, just as if Emailshooter were not in use. This means that the sender is guaranteed that the message will be delivered immediately if possible, and delivered as it always would have been if not.

Because the only user agent the sender and the recipient interact with is the same mail program they already know, the only overhead to using Emailshooter is to configure it and reconfigure the mail clients. After that, email appears to operate as it always did, except much faster when direct delivery is possible.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for direct transmission of email messages, when possible, falling back to traditional transmission when not possible comprising the steps of:
Standard email client software provides the entire user interface to this system;
A client program then becomes the email server with which this standard email client software communicates; and
The client program then communicates with the emailshooter locator server, which tells the client software whether the recipient is a participant in the service.
